(19) United States
(12) Patent Application Publication
(10) Pub. No.: US 2023/0176258 A1
(43) Pub. Date: Jun. 8, 2023

(54) POLARIZED LENS AND METHOD FOR PROVIDING A POLARIZED LENS

(71) Applicant: LUXOTTICA S.R.L., AGORDO (IT)

(72) Inventors: Antonio SIMEONE, TORINO (IT); Simone Luca TRAVERSO, FRAZIONE CORDOVA (IT); Vincenzo SPREMULLI, SAN MAURO TORINESE (IT)

(21) Appl. No.: 17/998,407

(22) PCT Filed: Jun. 16, 2021
(86) PCT No.: PCT/EP2021/066228

§ 371 Date: Nov. 10, 2022

(30) Foreign Application Priority Data
Jun. 18, 2020 (IT) 102020000014581

(51) Int. Cl. G02B 1/14; G02B 1/04; G02C 7/12; B29D 11/00

(52) U.S. Cl. CPC G02B 1/14; G02B 1/041; G02C 7/12; B29D 11/00865; B29D 11/00644; B29D 11/00009

(57) ABSTRACT

A polarized lens for eyeglasses and the like, which includes a polarizing wafer superimposed on a lens body made of polyamide material and at least one external layer of lacquering which coats externally the polarizing wafer and the lens body,
The polarizing wafer
   includes an internal polarizing layer between a first external layer of polyamide and a second external layer of polyamide,
   a first layer of glue interposed between the internal polarizing layer and the first external layer of polyamide, and
   a second layer of glue interposed between the internal polarizing layer and the second external layer of polyamide, The at least one external layer of lacquering includes at least one polysiloxane or acrylic lacquer.

### TECHNICAL FIELD

The present disclosure relates to a polarized lens for eyeglasses and the like.

### BACKGROUND

As is known, the term “polarized lens” commonly refers to lenses that are capable of filtering the component of light that has a certain polarization (for example horizontal light, i.e. the component of electromagnetic radiation that oscillates along horizontal planes) which is generally produced by reflection on reflecting surfaces like asphalt, water, snow, sand, metallic and horizontal surfaces etc.

By virtue of this characteristic, polarized lenses are capable of screening out the reverberation produced by reflection, and also of providing a better perception of contrasts, as well as clear vision even from afar.

Furthermore, polarized lenses generally also offer protection from UV rays and they can be colored according to requirements so as to also provide filtering similar to that of standard sunglass lenses.

Conventional polarized lenses are normally made of polycarbonate and are generally coated using lacquering processes that are entirely similar to the well-known processes used for non-polarized lenses.

In contrast to the considerable advantages listed above, conventional polarized lenses have a number of limitations and drawbacks, which include limitations in terms of mechanical characteristics and of versatility.

In more detail, an aspect of conventional polarized lenses that can be improved is surface hardness and scratch resistance.

Another aspect of conventional polarized lenses that can be improved is chemical resistance.

Another aspect with room for improvement is represented by the residual tensions that are created inside the lens during the production process.

Furthermore, conventional polarized lenses, and specifically lenses made of polycarbonate, are not suitable for mounting in frames of the frameless type because of the mechanical characteristics of the polycarbonate material.

Another drawback of conventional polarized lenses consists in the fact that, owing to the materials and the methods employed, the external lacquering must generally be preceded by the deposit of a primer.

Furthermore, conventional polarized lenses require production processes that are particularly long and complex, with lengthy thermal curing that can negatively influence the final quality of the product owing to the high thermal stresses to which the lenses are subjected.

### SUMMARY

The aim of the present disclosure is to provide a polarized lens that is capable of overcoming the abovementioned limitations of the known art.

Within this aim, an object of the present disclosure is to provide a polarized lens that has better mechanical characteristics than the known art.

The disclosure provides a polarized lens that has a high surface hardness and/or better scratch resistance.

The disclosure further provides a polarized lens that has high chemical resistance.

The disclosure also provides a polarized lens that has lower residual stresses than the known art.

the disclosure further provides a polarized lens that is more versatile and is also suitable for mounting on frameless mounts.

the disclosure also provides a polarized lens that is easy to implement and economically competitive when compared to the known art.

This aim and these and other advantages which will become more apparent hereinafter are achieved by providing a polarized lens according to the apparatus claims.

This aim and these and other advantages which will become more apparent hereinafter are also achieved by a method according to the corresponding method claims.

### BRIEF DESCRIPTION OF THE DRAWINGS

Further characteristics and advantages of the disclosure will become more apparent from the detailed description of a preferred, but not exclusive, embodiment of a polarized lens according to the disclosure and of a method for providing such lens, which are illustrated by way of non-limiting example with the aid of the accompanying drawings wherein:

FIG. 1 is an exploded view of a possible embodiment of a polarized lens according to the disclosure;

FIG. 2 is an exploded view of the polarizing wafer comprised in the lens of FIG. 1;

FIG. 3 is a side view of the polarizing wafer superimposed on the lens body;

FIG. 4 is a flowchart of a possible embodiment of the method for providing the polarized lens, according to the disclosure;

FIG. 5 is a flowchart of the details of a possible embodiment of the step of providing the polarizing wafer of the method of FIG. 1;

FIG. 6 is a flowchart of the details of a possible embodiment of the step of forming the lens body of the method of FIG. 1; and

FIG. 7 is a flowchart of the details of a possible embodiment of the steps of lacquering and surface treatment of the lacquering of the method of FIG. 1.

### DETAILED DESCRIPTION OF THE DRAWINGS

With reference to the figures, the polarized lens for eyeglasses and the like according to the disclosure, generally designated by the reference numeral 1, comprises a polarizing wafer (i.e. a polarizing structure or core) 20.

The term “polarizing” means, in entirely general terms, capable of providing the lens with the typical characteristic of polarized lenses, that is to say capable of filtering at least partially the component of light that has a certain polarization (for example horizontal light, i.e. the component of electromagnetic radiation that oscillates along horizontal planes) and therefore of obtaining the output of a light that is substantially polarized (along a direction perpendicular to that of the filtered component).

The polarizing wafer 20 is superimposed on a lens body 30 made of polyamide material (which can be aliphatic and/or cycloaliphatic and/or aromatic) and in particular optically transparent nylon (transparent in the sense that it is transparent to at least some visible light).

This polyamide material is preferably a polyamide resin with low viscosity, in particular containing a combination of diamines and of acids (for example dicarboxylic or carboxylic).

Conveniently, the resin with which the lens body 30 is made is a thermosetting resin.

In more detail, in the preferred embodiments, the polyamide resin comprises one or more materials selected from the following classes:
aliphatic,
cycloaliphatic,
aromatic.

In some embodiments the polyamide resin comprises one or more materials selected from the following compounds and classes of compounds:
polycarbonate (PC);
polymethylmethacrylate (PMMA);
polystyrene (PS);
cyclic olefin copolymers (COC);
ophthalmic resins.

The polarized lens 1 also comprises at least one external layer of lacquering 51, 52 which coats externally the polarizing wafer 20 and the lens body 30. In the preferred embodiments, there are at least one first layer of lacquering 51 which coats the external face of the polarizing wafer 20 and at least one second layer of lacquering 52 which coats the external face of the lens body 30.

Optionally, between the at least one external layer of lacquering 51, 52 and the polarizing wafer 20 and/or between the at least one external layer of lacquering 51, 52 and the lens body 30 there is a coating of adhesion promoter, such as for example one or more primers, the function of which is to facilitate the adhesion of the layer of lacquering 51, 52.

In addition or as an alternative to the primer, a surface treatment can be carried out that facilitates the adhesion of the lacquering, such as for example chemical treatments or physical treatments.

The abovementioned layer of adhesion promoter 41, 42 is preferably a water-based or solvent-based layer that has a solid component comprised between 1% and 40% and that comprises one or more of the following groups:
polyurethanes;
silanes;
aminic silanes.

In the preferred embodiments, the at least one external layer of lacquering 51, 52 comprises a polysiloxane lacquer and one or more acrylates (such as for example methacrylic acid (MAA), methyl methacrylate (MMA), polymethylmethacrylate (PMMA)).

In some embodiments, the at least one layer of lacquering 51, 52 comprises a methacrylic group and/or an epoxy group and/or silicones and/or polysiloxanes and/or polysilanes.

Optionally, in the layers of lacquering 51, 52 there are colloidal nanoparticles of silicon or of aluminum and/or hydrolyzed silanes in order to increase their mechanical strength.

Conveniently, the at least one layer of lacquering 51, 52 is provided so as to be abrasion-resistant, chemically resistant, and optically transparent.

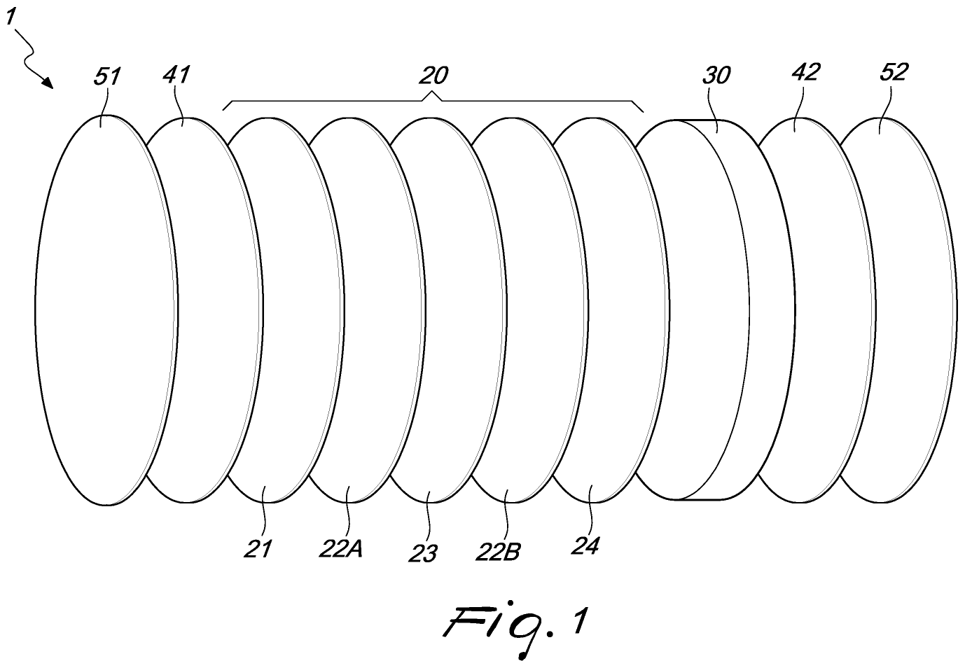

In the embodiment shown in FIG. 1, there is a first layer of adhesion promoter 41, which coats one of the layers of polyamide 21 of the polarizing wafer 20 (which will be described below) and which is in turn coated by a first layer of lacquering 51, and a second layer of adhesion promoter 42, which coats the external face of the lens body 30 and which is in turn coated by a second external layer of lacquering 52.

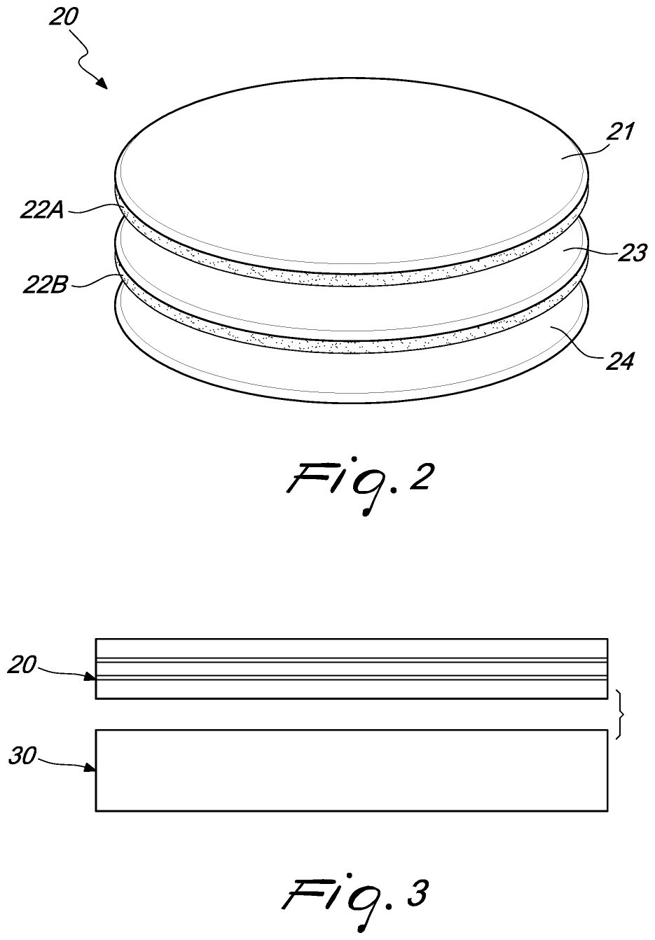

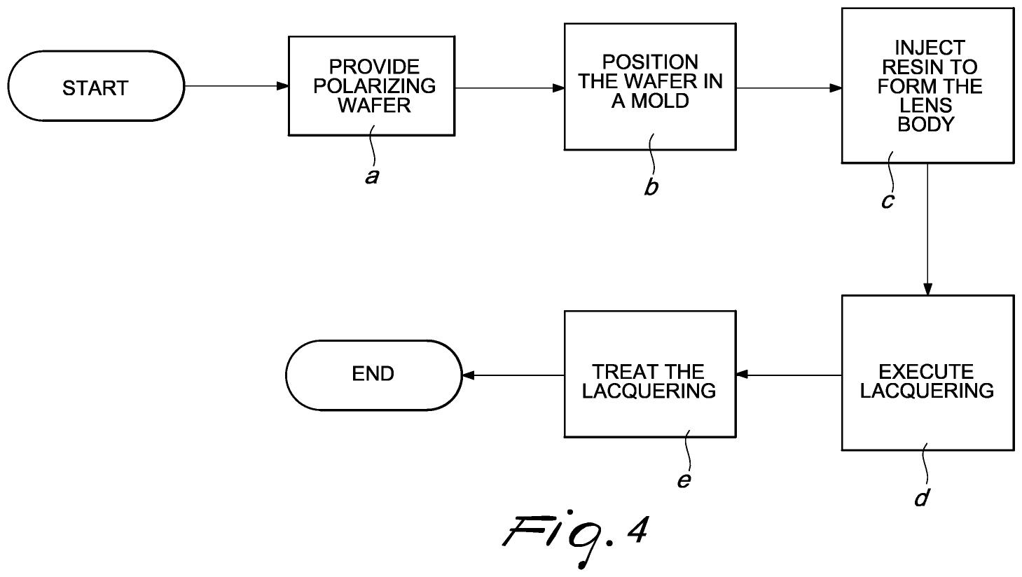

According to the disclosure, with particular reference to FIG. 2, the polarizing wafer 20 comprises an internal polarizing layer 23 comprised between a first external layer of polyamide 21 and a second external layer of polyamide 24.

The polarizing wafer 20 further comprises two layers of glue 22A, 22B which are interposed between the internal polarizing layer 23 and each one of the two external layers of polyamide 21, 24, these layers of glue 22A, 22B providing the adhesion between these layers 21, 23, 24, i.e.:
a first layer of glue 22A interposed between the internal polarizing layer 23 and the first external layer of polyamide 21, and
a second layer of glue 22B interposed between the internal polarizing layer 23 and the second external layer of polyamide 24.

The layers of polyamide 21, 24 are preferably of nylon, or, more generally, of an aromatic and/or aliphatic polyamide.

In the preferred embodiment, the first external layer of polyamide 21 is made of a stretched material, such as for example “stretched” nylon, and the second external layer of polyamide 24 is made of a non-stretched material, such as for example non-“stretched” nylon.

In other embodiments, both of the external layers of polyamide 21, 24 are made of stretched material, both stretched in the same way or stretched in different ways.

The internal polarizing layer 23 is configured to provide the polarizing effect inside the lens 1, can have different levels of polarization according to requirements, and preferably comprises a material selected from the following:
PVA (polyvinyl alcohol),
CTA (cellulose triacetate),
PET (polyethylene terephthalate).

In a preferred embodiment, the inner layer of polarizing material, preferably made of PVA, has a polarization efficiency higher than 40%.

In the preferred embodiments, the layers of glue 22A, 22B comprise one or more of the following types of glue: acrylic glue, epoxy glue, polyurethane-based glue, PVA (polyvinyl alcohol)-based glue, water-based glue.

In other embodiments the layers of glue 22A, 22B comprise a pressure adhesive (PSA, “Pressure Sensitive Adhesive”) or contact adhesive. So the term “layer of glue” therefore means, very generally, an adhesive element.

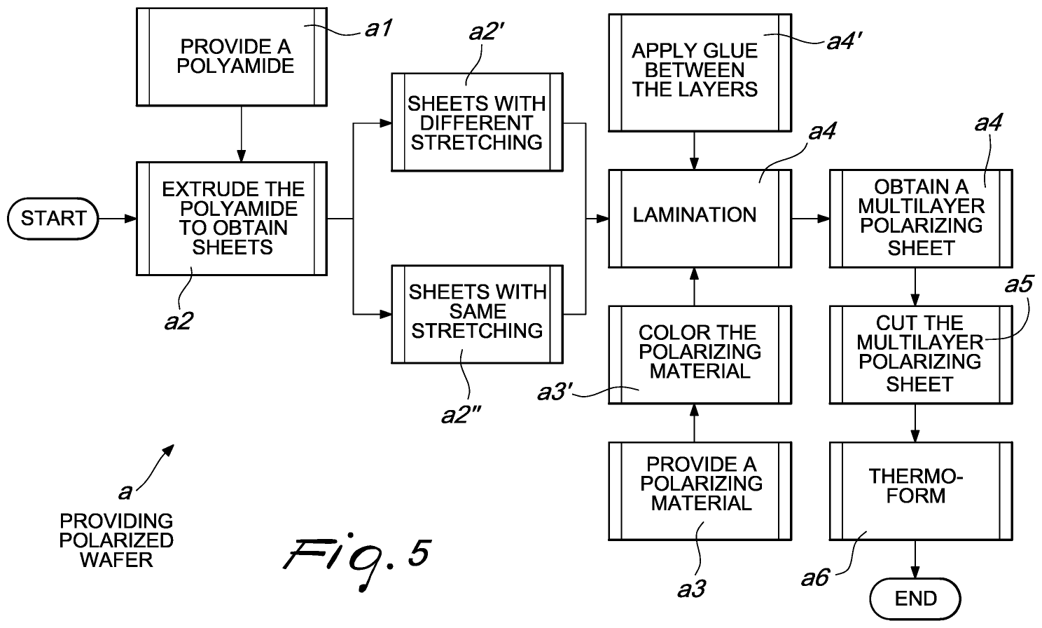

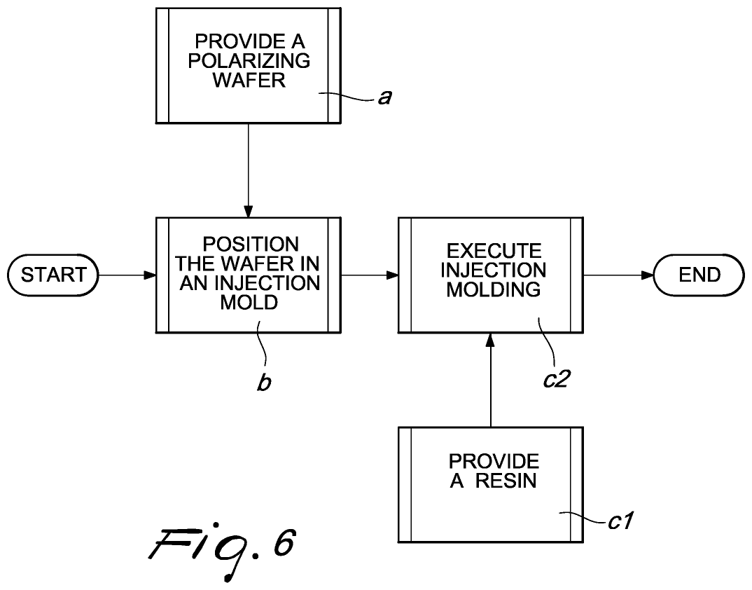

As summed up in the diagram of FIG. 4, the method for providing a polarized lens 1 for eyeglasses and the like, according to the disclosure, comprises the steps of:

a. providing a polarizing wafer 20 like one of those described previously;

b. positioning the polarizing wafer 20 inside a mold;

c. inserting a (low viscosity) resin into the mold, followed by the solidification of the resin so as to form a lens body 30 superimposed on the polarizing wafer 20, the resin preferably being injected with a suitable injection ramp, or poured.

d. executing a lacquering process by applying at least one external layer of lacquering 51, 52 which coats externally (i.e. the free external face of) the polarizing wafer 20 and the lens body 30.

Preferably, the method entails an additional step of:

e. treating the external layer of lacquering with heat and/or by way of UV treatment.

In more detail, the step a. of providing the polarizing wafer 20 is executed, for example as shown in FIG. 6, by way of the steps of:

a1. providing a polyamide;

a2. extruding the polyamide so as to obtain at least two sheets (preferably in rolls); the sheets are stretched both in the same way (step a2′), or only one is stretched, or they are stretched in different ways (step a2″);

a3. providing a polarizing material;

a3′. optionally, coloring the polarizing wafer and/or providing the polarizing wafer with other optical effects, such as photochromy, improved contrast and/or other optical effects known in the state of the art which conveniently modify transmittance under some light conditions and at some wavelengths in the light field of 280-1,400 nm, so as to modulate the visual comfort of the user;

a4. subjecting the two sheets of polyamide and the polarizing material to a lamination process in order to obtain a multilayer polarizing sheet in which a layer of polarizing material 23 is comprised between a first external layer of polyamide 21 and a second external layer of polyamide 24 (i.e. joining the two polyamide sheets to the polarizing material via a lamination process so as to obtain a multilayer polarizing sheet comprising an internal polarizing layer 23 comprised between a first external layer of polyamide 21 and a second external layer of polyamide 24);

a4′. before and/or during the lamination process, applying a glue 22B, 22B between the abovementioned layers 23, 21, 24 and more precisely: a first layer of glue 22A between the internal polarizing layer 23 and the first external layer of polyamide 21 and a second layer of glue 22B between the internal polarizing layer 23 and the second external layer of polyamide 24;

a5. cutting a portion of the multilayer polarizing sheet into a predefined shape suitable for the lens that it is desired to provide, by way of one of the cutting or trimming techniques known in the art (for example laser cutting);

a6. thermoforming the cut portion so as to obtain a polarizing wafer 20 that has a predetermined shape suitable for the lens that it is desired to provide.

Preferably, as shown in FIG. 6, the step c. of injecting a resin in order to form a lens body 30 comprises the steps of:

c1. providing a resin, preferably polyamide;

c2. executing an injection molding process, into the mold so as to obtain a lens body 30 that is coupled to the polarizing wafer 20, so as to obtain a polarized lens; in the injection molding method the resin is injected under pressure into the mold, following an adapted pressure ramp.

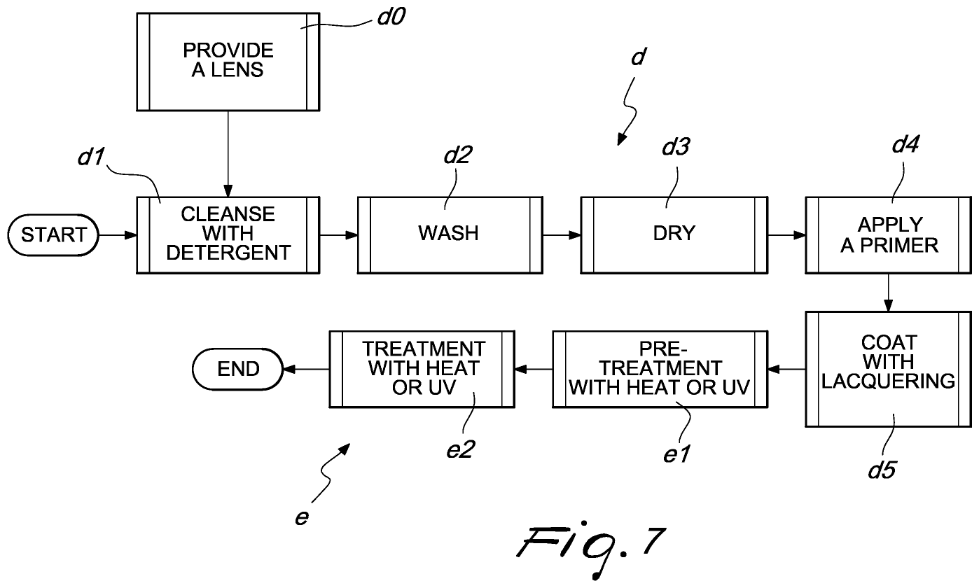

With particular reference to FIG. 7, in the preferred embodiments, the step d. of executing a lacquering process comprises the steps of:

d1. cleaning the lens obtained in step c. with one or more detergents;

d2. washing the lens with demineralized water;

d3. drying the lens;

d5. coating the lens with one or more layers of lacquering, for example by immersing the lens in a lacquering (or paint) chemical bath.

In more detail, the coating of the lens with the layer of lacquering is carried out preferably by way of one of the following methods:
spreading by immersion, commonly known as Dip Coating,
flow painting, commonly known as Flow Coating,
coating via centrifugation, commonly known as Spin Coating,
coating via spraying, commonly known as Spray Coating,
coating via ultrasonic spraying, commonly known as Ultrasonic Spray Coating.

Optionally, before the step d5. of coating the lens with one or more layers of lacquering, the following step is executed:

d4. applying a coating of adhesion promoter (such as for example a primer);

as an alternative or in addition to step d4. a surface treatment is carried out that facilitates the adhesion of the lacquering, such as chemical treatments or physical treatments.

Finally the lens obtained can be further shaped and/or treated, according to necessity, for example with mirroring processes using vacuum PVD, and/or be coated with an additional hydro/oil-repellent layer or any type of treatment (laser cutting and other decorations) that modifies the final surface tensions of the lens in order to obtain angles of contact comprised between 0° and 180°.

Optionally, there can be an additional layer of material with purely aesthetic and decorative functions between the polyamide layer 24 and the lens body 30 and/or between the polyamide layer 21 and the optional layer of adhesion promoter 41 or the layer of lacquering 52; such functions can be obtained with different techniques in the following non-exhaustive list which includes: laser cutting, perforation, UV printing, adhesive bonding.

With regard to the details of the materials used in the method, these are the same and have the same characteristics described previously with reference to the lens 1 and therefore, for the sake of brevity, are not repeated here.

It is important to emphasize that in the method according to the disclosure it is advantageously possible to obtain the lens 1 without resorting to the layer of primer which, as has been mentioned, is optional.

The operation of the polarized lens 1 is known per se. We point out only that the polarized lens 1 thus provided has mechanical characteristics and versatility that are improved over conventional lenses, and that in particular it can also be mounted on mounts that are frameless or made of acetate.

In particular, from tests conducted, the Applicant has found that the lens according to the disclosure has the following improved characteristics over conventional standard polarized lenses:
faster processability than standard lenses, with a step of cross-linking comprised between 1-60 sec;
improved chemical resistance and improved resistance to environmental tests;
improved Vickers nano-indentation surface hardness with respect to the standard, up to a maximum of 50VH;
improved stretch modulus of the scratch resistant layer, up to a maximum of 4.0 GPa.

In practice it has been found that the polarized lens according to the present disclosure achieves the intended aim and objects in that it has a high surface hardness and better scratch resistance.

Another advantage of the polarized lens, according to the disclosure, consists in the fact that it has high chemical resistance.

Another advantage of the polarized lens according to the disclosure consists in the fact that it has lower residual stresses than the known art.

Another advantage of the polarized lens, according to the disclosure, consists in the fact that it is easy to implement and economically competitive when compared to the known art.

The polarized lens and the method for providing such lens, thus conceived, are susceptible of numerous modifications and variations, all of which are within the scope of the appended claims.

Moreover, all the details may be substituted by other, technically equivalent elements.

Thus, for example, the lens body 30 can be tinted. The hues (colorings of the lens body) can be of any type or pattern, by way of non-exhaustive example, classic graduated hue, circular hue, overlapping hue, clear-edged hue or shaped hue.

In practice, the materials used, as well as the contingent shapes and dimensions, may be any according to the requirements and to the state of the art.

The disclosures in Italian Patent Application No. 102020000014581 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1. A polarized lens for eyeglasses comprising: a polarizing wafer superimposed on a lens body made of polyamide material and at least one external layer of lacquering which coats externally said polarizing wafer and said lens body,
wherein said polarizing wafer comprises:
an internal polarizing layer comprised between a first external layer of polyamide and a second external layer of polyamide,
a first layer of glue interposed between the internal polarizing layer and the first external layer of polyamide, and
a second layer of glue interposed between the internal polarizing layer and the second external layer of polyamide,
and wherein said at least one external layer of lacquering comprises at least one polysiloxane or acrylic lacquer.

2. The polarized lens according to claim 1, wherein said lens body is constituted by a polyamide resin.

3. The polarized lens according to claim 2, wherein said polyamide resin comprises one or more materials selected from the group consisting of:
aliphatic,
cycloaliphatic, and
aromatic.

4. The polarized lens according to claim 1, wherein said internal polarizing layer comprises a material selected from the group consisting of:
PVA,
CTA, and
PET.

5. The polarized lens according to claim 1, wherein said at least one external layer of lacquering comprises a polysiloxane and acrylic lacquer.

6. The polarized lens according to claim 1, further comprising a coating of adhesion promoter between said at least one external layer of lacquering and said polarizing wafer and/or between said at least one external layer of lacquering and said lens body.

7. The polarized lens according to claim 1, wherein the first external layer of polyamide is made of stretched material and the second external layer of polyamide is made of non-stretched material.

8. A method for providing a polarized lens for eyeglasses, the method including the following steps of:
a. providing a polarizing wafer which comprises an internal polarizing layer comprised between a first external layer of polyamide and a second external layer of polyamide, a first layer of glue interposed between the internal polarizing layer and the first external layer of polyamide, and a second layer of glue interposed between the internal polarizing layer and the second external layer of polyamide,
b. positioning the polarizing wafer inside a mold,
c. inserting a resin in the mold so as to form a lens body superimposed on the polarizing wafer; and
d. executing a lacquering process by applying at least one external layer of lacquering which coats externally said polarizing wafer and said lens body.

9. The method according to claim 8, wherein said step a. of providing a polarizing wafer further includes the following steps:
a1. providing a polyamide,
a2. extruding said polyamide to obtain at least two sheets of polyamide
a3. providing a polarizing material
a4. subjecting the two sheets of polyamide and the polarizing material to a lamination process in order to obtain a multilayer polarizing sheet in which a layer of polarizing material is comprised between a first external layer of polyamide and a second external layer of polyamide,
a4′. before and/or during said lamination process, applying a glue between said layers,
a5. cutting a portion of said multilayer polarizing sheet into a predefined shape, and
a6. thermoforming the cut portion so as to obtain a polarizing wafer that has a predetermined shape suitable for the lens to be provided.

10. The method according to claim 8, wherein said step c. of injecting a resin in order to form a lens body further includes the following steps:
c1. providing a resin, and
c2. executing an injection molding process, injecting the resin into the mold to obtain a lens body that is coupled to the polarizing wafer, to obtain a polarized lens.

11. The method according to claim 8, wherein said step d. of executing a lacquering process further includes the following steps:
d1. cleaning the lens obtained in step c. with one or more detergents,
d2. washing the lens with water,
d3. drying the lens, and
d5. coating the lens with one or more layers of lacquering.

12. The method according to claim 11, wherein said step d. comprises, before said step d5. of coating the lens with one or more layers of lacquering, the following step of:
d4. applying a coating of adhesion promoter and/or executing a surface treatment that facilitates the adhesion of the lacquering.
